(19) United States
(12) Patent Application Publication
(10) Pub. No.: US 2012/0086778 A1
(43) Pub. Date: Apr. 12, 2012

(54) TIME OF FLIGHT CAMERA AND MOTION TRACKING METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/156,354

(22) Filed: Jun. 9, 2011

(30) Foreign Application Priority Data
Oct. 12, 2010 (TW) 99134811

(51) Int. Cl. H04N 13/02

(52) U.S. Cl. 348/46; 348/E13.074

(57) ABSTRACT

In a motion tracking method using a time of flight (TOF) camera that is installed on a track system, three-dimensional (3D) images of people are captured using the TOF camera, and stored in a storage system to create a 3D image database. Scene images of a monitored area are captured in real-time and analyzed to check for motion. A movement direction of the motion is determined once motion has been detected and the TOF camera is moved along the track system to track the motion using a driving device according to the movement direction.

### BACKGROUND

1. Technical Field

Embodiments of the present disclosure relate generally to surveillance technology, and more particularly, to a time of flight camera and a motion tracking method using the time of flight camera.

2. Description of Related Art

Cameras installed on a track system have been used to perform security surveillance by capturing images of a monitored area. A camera installed on the track system can automatically and can regularly move along the track system but cannot respond to specific movements.

### BRIEF DESCRIPTION OF THE DRAWINGS

FIG. 1 is a block diagram of one embodiment of a time of flight (TOF) camera.

FIG. 2 is a schematic diagram illustrating one example of the TOF camera installed on a track system.

FIG. 3 is a schematic diagram illustrating an example of a three dimensional (3D) digital image of a person captured by the TOF camera of FIG. 1.

FIGS. 4A-C are schematic diagrams of one embodiment of a control system for controlling the movements of the TOF camera along the track system according to a specific movement.

FIGS. 5A-5B are schematic diagrams of one embodiment of the zooming function in the TOF camera.

FIG. 6 is a flowchart of one embodiment of a motion tracking method using the TOF camera of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

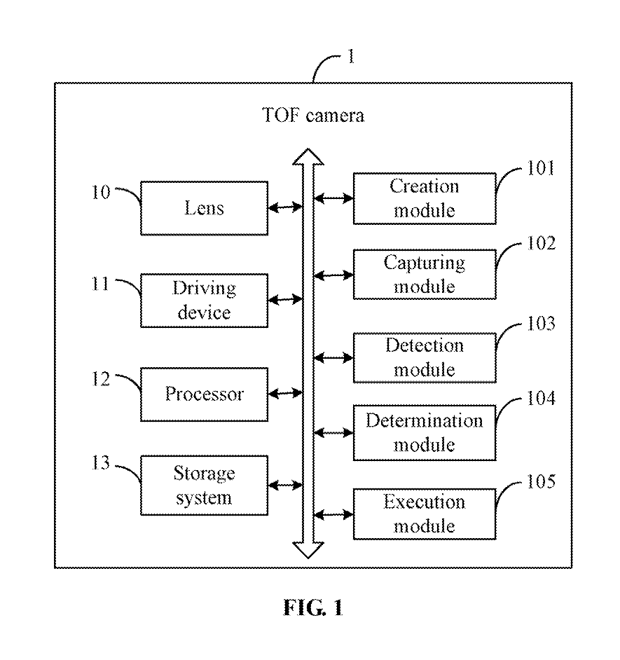

FIG. 1 is a block diagram of one embodiment of a time of flight (TOF) camera 1. In the embodiment, the TOF camera 1 includes a lens 10, a driving device 11, a processor 12, and a storage system 13. The TOF camera 1 may further include a creation module 101, a capturing module 102, a detection module 103, a determination module 104, and an execution module 105. The TOF camera 1 in FIG. 1 is an example only, another TOF camera 1 can include more or less components than shown in other embodiments, or with the various components differently configured.

Each of the modules 101-105 may include one or more computerized instructions in the form of one or more programs that are stored in the storage system 13 or a computer-readable medium, and executed by the processor 12 to perform operations of the TOF camera 1. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

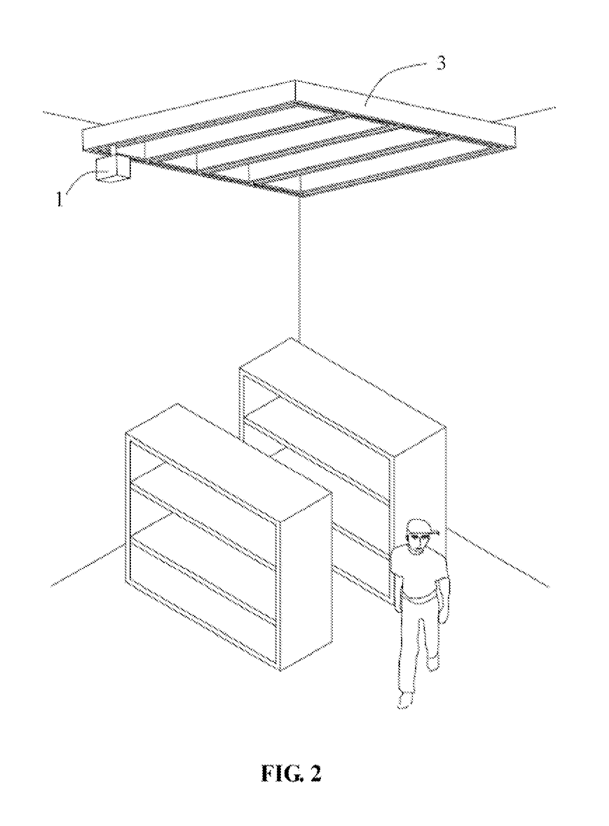

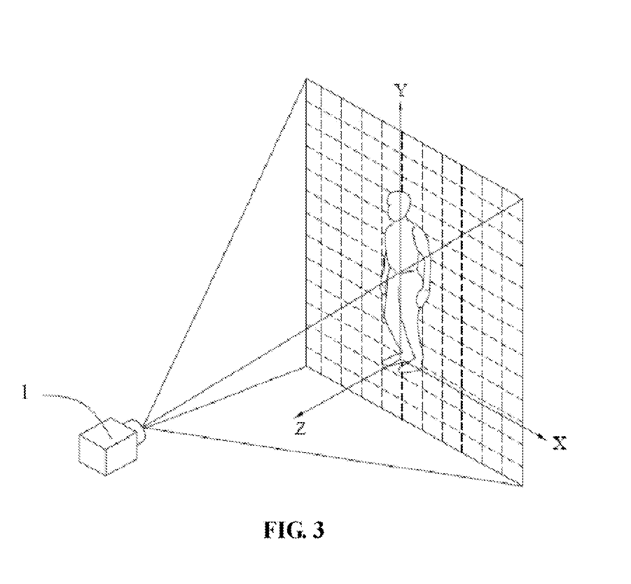

Referring to FIG. 2, the TOF camera 1 is installed on a track system 3. The track system 3 comprises one or more tracks, and the TOF camera 1 can be directed to move along any track according to a specific motion that is detected in a monitored area, such as human movement. The monitored area may be the interior of a warehouse, a supermarket, a bank, or any other place to be monitored. The track system 3 may be installed above the monitored area or in any other suitable location.

The driving device 11 may be used to move the TOF camera 1 along the tracks of the track system 3 to track detected motion. In one embodiment, the driving device 11 may be composed of one or more servo motors.

The creation module 101 is operable to capture a plurality of three dimensional (3D) images of people, using the lens 10, and store the images in the storage system 10 to create a 3D image database. In the embodiment, each of the 3D images comprises characteristic human data such as facial features (e.g., nose, eyes and mouth shape and size), and the general dimensions of a human being.

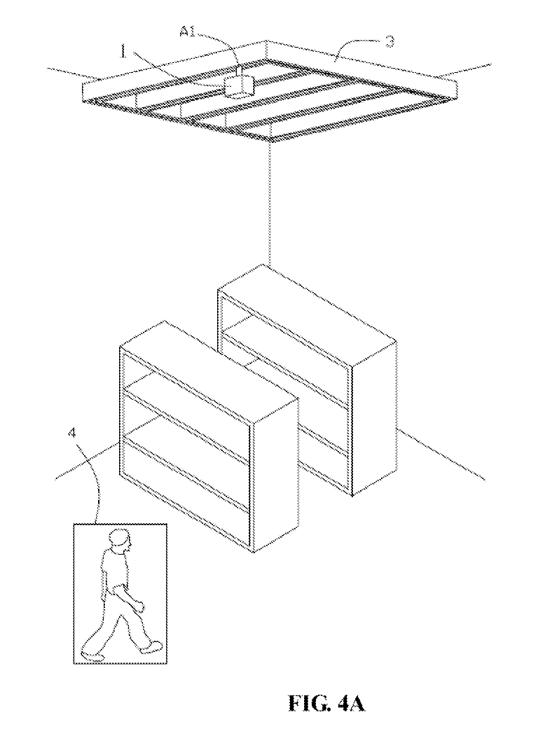

The capturing module 102 is operable to control the lens 10 to capture scene images of the monitored area in real-time. In one embodiment, the capturing module 101 may control the lens 10 to capture a scene image at regular intervals, such as one or two seconds. Each of the scene images may include not only the image data but, in addition, data as to the distance information between the lens 10 and objects in the monitored area. As an example, referring to FIG. 3, an image of a person in the monitored area is captured. The person image may be described using a three dimensional (3D) coordinate system that includes the X and Y and Z coordinates. In one embodiment, the X-coordinate value may represent the width of the person, for example 20 cm. The Y-coordinate value may represent the height of the person, such as, 160 cm. The Z-coordinate may represent the distance information between the lens 10 and the person, which may be calculated by analysis of the image of the person.

The detection module 103 is operable to analyze the scene images to check for motion in the monitored area. In the embodiment, the motion may be defined as human movement in the monitored area. The detection module 103 may refer to the 3D images of the database to determine a human presence in the monitored area and to determine motion by a person.

The determination module 104 is operable to determine a movement direction of the motion when the motion is detected in the monitored area. In the embodiment, the determination module 104 may determine the movement direction of the motion by comparing the respective positions of the motion within two scene images of the monitored area that are consecutively captured by the lens 10.

The execution module 105 is operable to control the TOF camera 1 to move along the track system 3 to track the motion according to the movement direction using the driving device 11. For example, if a person moves towards the left hand side of the monitored area, the execution module 105 may control the TOF camera 1 to move correspondingly on the track system 3. If the person moves towards the right hand side of the monitored area, the execution module 105 may control the TOF camera 1 to move accordingly on the track system 3.

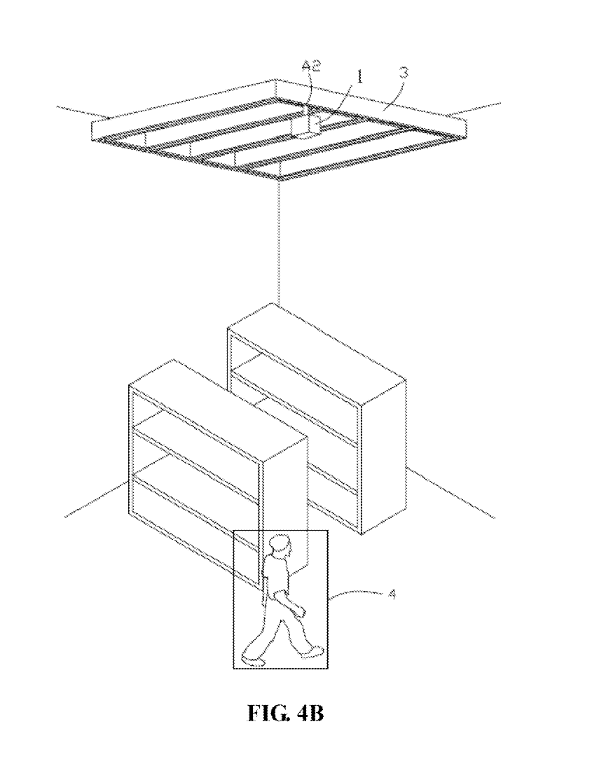

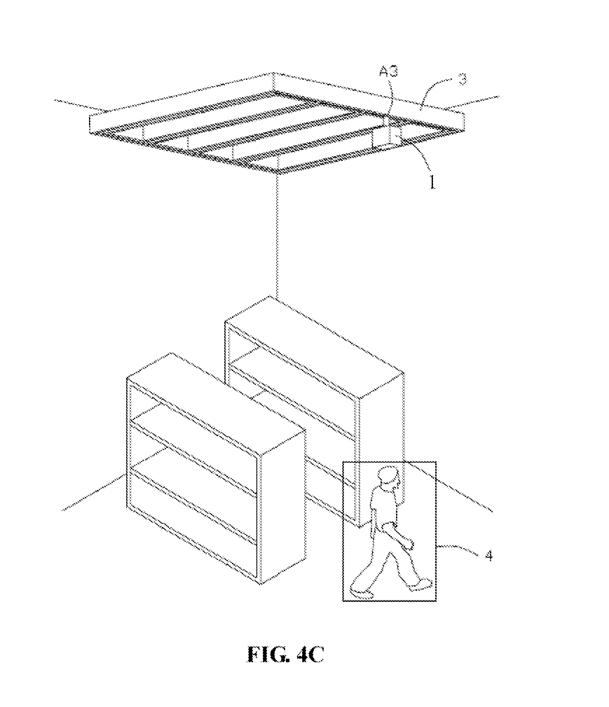

Referring to FIGS. 4A-4C, the TOF camera 1 moves from a first position “A1” to a second position “A2” along the track system 3 when a person (person 4) moves towards the right hand side of the monitored area. Then, the TOF camera 1 moves again from the second position “A2” to a third position “A3” along the track system 3 when the person 4 moves further to the right.

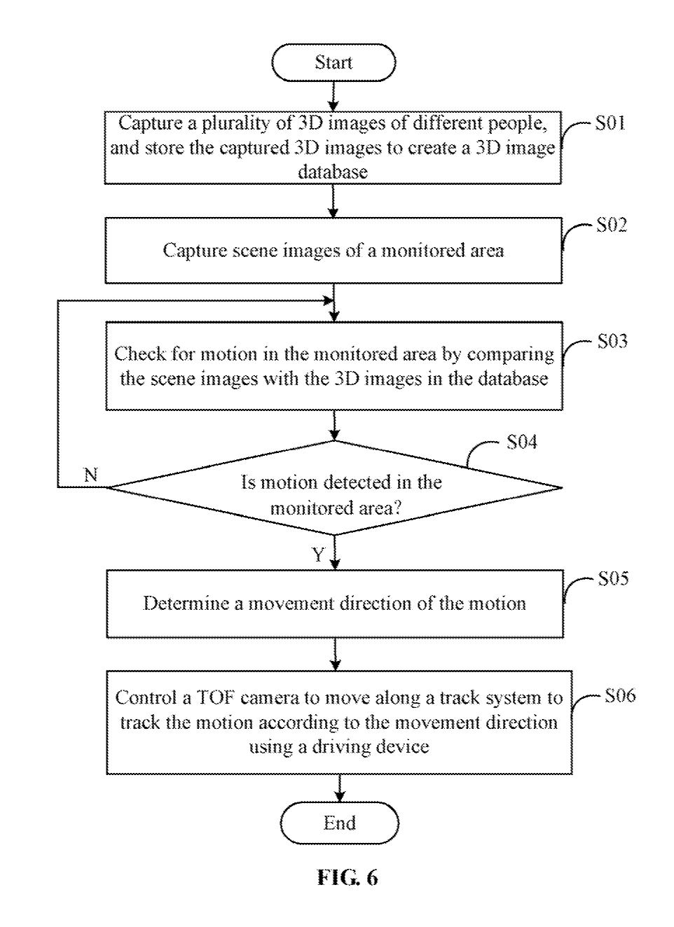

FIG. 6 is a flowchart of one embodiment of a motion tracking method using the TOF camera 1 of FIG. 1. Depending on the embodiment, additional blocks may be added and others removed, and the ordering of the blocks may be changed.

In block S01, the creation module 101 captures a plurality of three dimensional (3D) images of people, using the lens 10, and stores the images in the storage system 10 to create a 3D image database. In the embodiment, each of the 3D images comprises characteristic general human data, such as the facial features (e.g., the general shape and size of the nose, eyes and mouth), and general dimensions of the human outline.

In block S02, the capturing module 102 controls the lens 10 to capture scene images of the monitored area in real-time. In one embodiment, the capturing module 101 may direct the capture of a scene image at regular intervals, such as one or two seconds.

In block S03, the detection module 103 analyzes the scene images to check for motion in the monitored area. In one embodiment, the motion may be defined as human movement in the monitored area. The detection module 103 may compare each of the scene images with the 3D images in the database to determine a human presence in the monitored area to check for the motion.

In block S04, the detection module 103 determines whether motion is detected in the monitored area. If motion is detected in the monitored area, block S05 is implemented. Otherwise, if no motion is detected in the monitored area, block S03 is repeated.

In block S05, the determination module 104 determines a movement direction of the motion. In the embodiment, the determination module 104 may determine the movement direction of the motion by comparing the respective positions of the motion within two consecutive scene images of the monitored area.

In block S06, the execution module 104 controls the TOF camera 1 to move along the track system 3 to track the motion using the driving device 11 according to the movement direction of the motion. Details of such control have been provided above.

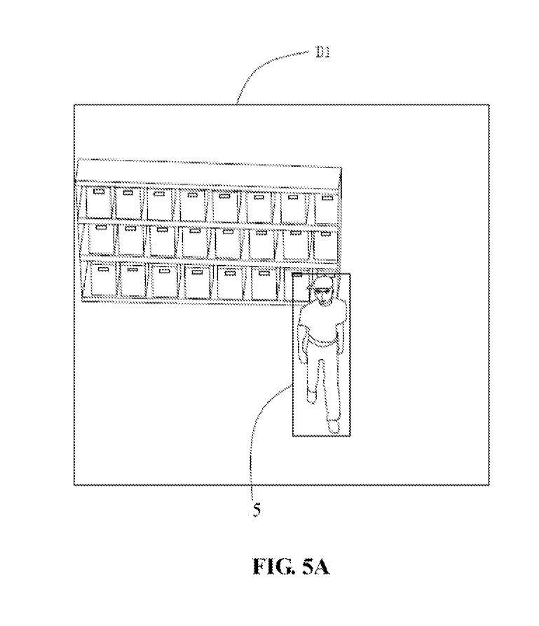

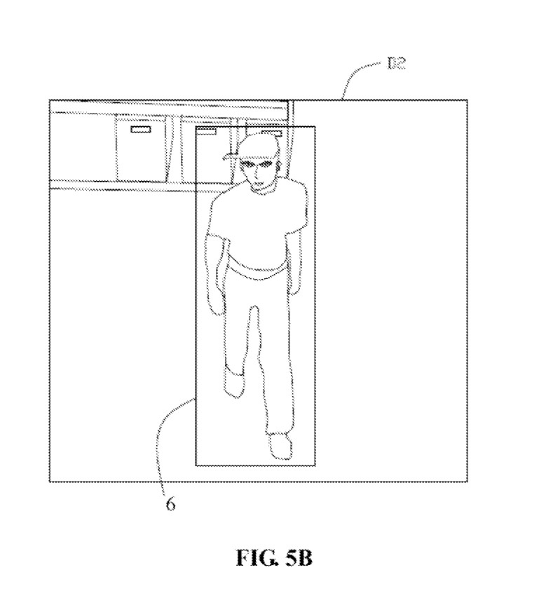

In other embodiments, the detection module 103 further extracts the smallest possible rectangle which encloses a complete picture of the motion from a current scene image of the monitored area after the TOF camera 1 has been moved, and determines whether the ratio of that smallest possible rectangle is less than a preset value (e.g., 20%) of the full current scene image. If the ratio of that smallest rectangle is less than the preset value, the execution module 105 controls the TOF camera 1 to pan and/or tilt the lens 10 until the center of that smallest rectangle is at the center of the current scene image viewed by the TOF camera 1. To obtain a magnified or zoomed image of the motion, the execution module 105 directs the TOF camera 1 to increase the magnification of the current scene until the ratio of the smallest possible rectangle that encloses the complete picture of the motion is equal to or greater than the preset value of the full current scene image being viewed by the TOF camera 1. As an example, referring to FIGS. 5A-5B, “D1” represents a captured scene image when the person 4 is detected in the monitored area. “D2” represents substantially the same scene image of the monitored area after the magnification or zoom function of the TOF camera 1 has been applied.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A motion tracking method using a time of flight (TOF) camera, the TOF camera being installed on a track system, the method comprising:
capturing a plurality of three dimensional (3D) images of people using a lens of the TOF camera, and storing the 3D images in a storage system of the TOF camera to create a 3D image database;
controlling the lens to capture scene images of a monitored area in real-time;
analyzing the scene images to check for motion in the monitored area by comparing each of the scene images with the 3D images in the database;
determining a movement direction of the motion when the motion is detected in the monitored area; and
controlling the TOF camera to move along the track system to track the motion using a driving device according to the movement direction.

2. The method according to claim 1, wherein the motion is defined as human movement in the monitored area.

3. The method according to claim 1, wherein the movement direction of the motion is determined by comparing the respective positions of the motion within two consecutive scene images of the monitored area.

4. The method according to claim 1, further comprising:
extracting the smallest possible rectangle which encloses a complete picture of the motion from a current scene image of the monitored area after the TOF camera has been moved;
determining whether the ratio of that smallest possible rectangle is less than a preset value of the full current scene image;
controlling the TOF camera to pan and/or tilt the lens until the center of that smallest rectangle is at the center of the current scene image viewed by the TOF camera if the ratio of that smallest possible rectangle is less than the preset value; and
directing the TOF camera to increase the magnification of the current scene until the ratio of the smallest possible rectangle that encloses the complete picture of the motion is equal to the preset value of the full current scene image being viewed by the TOF camera.

5. A time of flight (TOF) camera for motion tracking, the TOF camera being installed on a track system, the TOF camera comprising:
a lens, a driving device, at least one processor, and a storage system; and
one or more programs stored in the storage system and being executable by the at least one processor, wherein the one or more programs comprises:
a creation module operable to capture a plurality of three dimensional (3D) images of different people using the lens, and store the 3D images in the storage system to create a 3D image database;
a capturing module operable to control the lens to capture scene images of a monitored area in real-time;
a detection module operable to analyze the scene images to check for motion in the monitored area by comparing each of the scene images with the 3D images in the database;
a determination module operable to determine a movement direction of the motion when the motion is detected in the monitored area; and
an execution module operable to control the TOF camera to move along the track system to track the motion using a driving device according to the movement direction.

6. The TOF camera according to claim 5, wherein the motion is defined as human movement in the monitored area.

7. The TOF camera according to claim 5, wherein the movement direction of the motion is determined by comparing the respective positions of the motion within two consecutive scene images of the monitored area.

8. The TOF camera according to claim 5, wherein the detection module is further operable to extract the smallest possible rectangle which encloses a complete picture of the motion from a current scene image of the monitored area after the TOF camera has been moved, and determine whether the ratio of that smallest possible rectangle is less than a preset value of the full current scene image.

9. The TOF camera according to claim 8, wherein the execution module is further operable to control the TOF camera to pan and/or tilt the lens until the center of that smallest rectangle is at the center of the current scene image viewed by the TOF camera if the ratio of that smallest possible rectangle is less than the preset value, and direct the TOF camera to increase the magnification of the current scene until the ratio of the smallest possible rectangle that encloses the complete picture of the motion is equal to the preset value of the full current scene image being viewed by the TOF camera.

10. A non-transitory storage medium storing a set of instructions, the set of instructions capable of being executed by a processor of a time of flight (TOF) camera that is installed on a track system, causing the TOF camera to perform a motion tracking method, the method comprising:
capturing a plurality of three dimensional (3D) images of people using a lens of the TOF camera, and storing the 3D images in a storage system of the TOF camera to create a 3D image database;
controlling the lens to capture scene images of a monitored area in real-time;
analyzing the scene images to check for motion in the monitored area by comparing each of the scene images with the 3D images in the database;
determining a movement direction of the motion when the motion is detected in the monitored area; and
controlling the TOF camera to move along the track system to track the motion using a driving device according to the movement direction.

11. The storage medium as claimed in claim 10, wherein the motion is defined as human movement in the monitored area.

12. The storage medium as claimed in claim 10, wherein the movement direction of the motion is determined by comparing the respective positions of the motion within two consecutive scene images of the monitored area.

13. The storage medium as claimed in claim 10, wherein the method further comprises:
extracting the smallest possible rectangle which encloses a complete picture of the motion from a current scene image of the monitored area after the TOF camera has been moved;
determining whether the ratio of that smallest possible rectangle is less than a preset value of the full current scene image;
controlling the TOF camera to pan and/or tilt the lens until the center of that smallest rectangle is at the center of the current scene image viewed by the TOF camera if the ratio of that smallest possible rectangle is less than the preset value; and
directing the TOF camera to increase the magnification of the current scene until the ratio of the smallest possible rectangle that encloses the complete picture of the motion is equal to the preset value of the full current scene image being viewed by the TOF camera.
